(19) United States
(12) Patent Application Publication
(10) Pub. No.: US 2017/0300952 A1
(43) Pub. Date: Oct. 19, 2017

(54) Lodging Reward System and Methods of Use

(71) Applicant: Guestbook Rewards, Inc., West Hollywood, CA (US)

(72) Inventor: James Jeffrey Gancos, West Hollywood, CA (US)

(73) Assignee: Guestbook Rewards, Inc., West Hollywood, CA (US)

(21) Appl. No.: 15/130,897

(22) Filed: Apr. 15, 2016

(51) Int. Cl. G06Q 30/02; G06Q 10/02

(52) U.S. Cl. CPC G06Q 30/0226; G06Q 10/02

(57) ABSTRACT

A lodging reward system and associated methods are configured for incentivizing an at least one user by providing said user with an at least one reward, having a redeemable value, in exchange for booking stays at more than one lodging facility. In at least one embodiment, upon the user desiring to book a stay at a desired lodging facility, a booking cost is calculated. For any rewards associated with the user, it is determined whether a distance between an originating location, associated with each said reward, and the desired lodging facility is greater than a pre-defined minimum distance and, if so, a bonus amount is calculated for said reward and added to an aggregated bonus total. Upon the user electing to redeem a specified amount of the bonus total toward the booking cost, the specified amount is deducted the from the bonus total, along with a proportional amount from the reward amount of the at least one associated reward.

### BACKGROUND

The subject of this patent application relates generally to customer reward programs, and more particularly to a lodging reward system and associated methods of use configured for incentivizing lodging guests to book stays at a variety of lodging facilities.

Applicant(s) hereby incorporate herein by reference any and all patents and published patent applications cited or referred to in this application.

By way of background, customer loyalty programs are structured marketing strategies designed to incentivize and encourage customers to continue to shop at or use the services of businesses associated with each program. By participating in such programs, customers typically earn the right to either a discount on a current purchase, or to an allotment of points that they may use for future purchases. Some programs even provide customers with the option of redeeming accumulated points for cash. Many lodging facilities—such as hotels, motels, hostels, etc.—provide such loyalty programs through which their guests are able to earn points (redeemable for discounts, future stays, cash back, or other prizes or benefits) or airline miles, for example. However, such programs typically only reward guests for staying at the particular lodging facility responsible for administering the program, by limiting guests' ability to redeem points only at the lodging facility where those points were earned. Thus, participants of such loyalty programs are less likely to book stays at other lodging facilities, which could result in relatively lower revenues for such other lodging facilities and the surrounding businesses as a result of the potential lack of tourism. Furthermore, while some loyalty programs support multiple lodging facilities—such that participants may earn and redeem points at any supported lodging facility—such programs fail to encourage participants to try different lodging facilities within the program. Thus, there remains a need for a system configured for incentivizing lodging guests to book stays at a variety of lodging facilities.

Aspects of the present invention fulfill these needs and provide further related advantages as described in the following summary.

### SUMMARY

Aspects of the present invention teach certain benefits in construction and use which give rise to the exemplary advantages described below.

The present invention solves the problems described above by providing a lodging reward system and associated methods for incentivizing an at least one user by providing said user with an at least one reward, having a redeemable value, in exchange for booking stays at more than one lodging facility. In at least one embodiment, a central computing system is configured for receiving and processing data related to the at least one user and associated at least one reward. A user account associated with the at least one user contains at least one of a unique account identifier, a reward table containing details related to each of the at least one reward that has been earned by the associated user, and a reward balance containing an aggregated total redeemable value of the at least one reward contained in the reward table. Upon a one of the at least one user desiring to book a stay at a desired lodging facility, a booking cost for the user's desired stay is calculated. Additionally, for any rewards contained in the reward table of the associated user account, it is determined whether a distance between an originating location, associated with each said reward, and the desired lodging facility is greater than a pre-defined minimum distance and, if so, a bonus amount is calculated for said reward. The at least one bonus amount is added to a bonus total representing an aggregated redeemable value of the at least one bonus amount. Upon the user electing to redeem a specified amount of the bonus total toward the booking cost, the computing system deducts the specified amount from the bonus total, and also deducts a proportional amount from the reward amount of the at least one associated reward.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a simplified schematic view of an exemplary lodging reward system, in accordance with at least one embodiment;

FIG. 2 is an architecture diagram of an exemplary user account, in accordance with at least one embodiment;

FIG. 3 is an architecture diagram of an exemplary reward, in accordance with at least one embodiment; and

FIGS. 4 and 5 are flow diagrams of exemplary methods for administering the lodging reward system, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

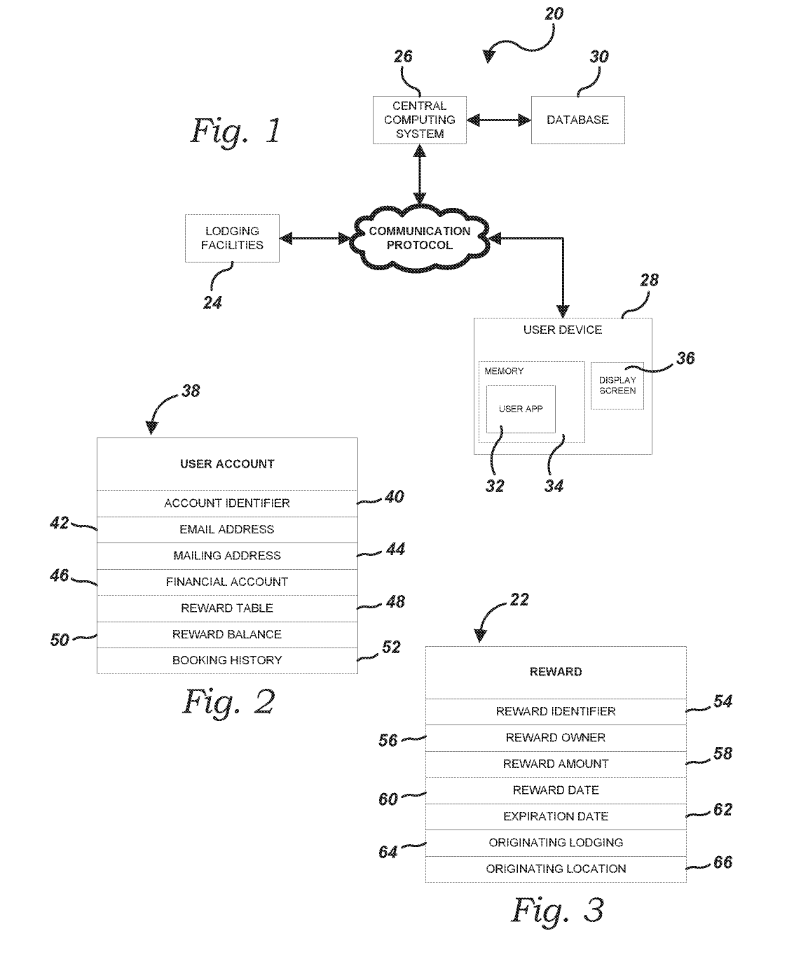

Turning now to FIG. 1, there is shown a simplified schematic view of an exemplary lodging reward system 20 configured for incentivizing an at least one lodging guest (hereinafter referred to as a “user”) by providing an at least one reward 22 in exchange for booking stays at more than one participating lodging facility 24, in accordance with at least one embodiment. The system 20 provides, in at least one embodiment, a central computing system 26 configured for receiving and processing data related to the at least one user and associated at least one reward 22, along with each of the lodging facilities 24. An at least one user device 28 is in selective communication with the computing system 26.

Additionally, in at least one embodiment, an at least one database 30 is in communication with the computing system 26 and configured for selectively storing said data related to the at least one user and associated at least one reward 22, along with each of the lodging facilities 24. Additionally, in at least one embodiment, at least one of the computing system 26 and at least one user device 28 is in selective communication with the each of the lodging facilities 24. In at least one embodiment, the computing system 26 and database 30 are one and the same—as such, it is intended that those terms as used herein are to be interchangeable with one another. In at least one embodiment, the computing system 26 and database 30 are omitted, such that the system 20 and associated methods described herein are implemented solely through the at least one user device 28—thus, any methods or functionality described herein as being carried out by the computing system 26 or database 30 may, in at least one embodiment, also be carried out by the at least one user device 28, regardless of whether such embodiments nevertheless incorporate the computing system 26 and/or database 30.

At the outset, it should be noted that communication between each of the computing system 26, at least one user device 28, and at least one database 30 may be achieved using any wired- or wireless-based communication protocol (or combination of protocols) now known or later developed. As such, the present invention should not be read as being limited to any one particular type of communication protocol, even though certain exemplary protocols may be mentioned herein for illustrative purposes. It should also be noted that the term “user device” is intended to include any type of computing or electronic device, now known or later developed, capable of communicating with the computing system 26—such as desktop computers, mobile phones, smartphones, laptop computers, tablet computers, personal data assistants, gaming devices, wearable devices, etc. As such, the present invention should not be read as being limited to use with any one particular type of computing or electronic device, even though certain exemplary devices may be mentioned or shown herein for illustrative purposes.

With continued reference to FIG. 1, in the exemplary embodiment, each of the computing system 26, at least one user device 28, and at least one database 30 contains the hardware and software necessary to carry out the exemplary methods for administering the lodging reward system 20, as described herein. Furthermore, in at least one embodiment, the computing system 26 comprises a plurality of computing devices selectively working in concert with one another to carry out the exemplary methods for administering the lodging reward system 20, as described herein. In at least one embodiment, the at least one user device 28 provides a user application 32 residing locally in memory 34 on the user device 28, the user application 32 being configured for selectively communicating with the computing system 26, as discussed further below. It should be noted that the term “memory” is intended to include any type of electronic storage medium (or combination of storage mediums) now known or later developed, such as local hard drives, RAM, flash memory, secure digital (“SD”) cards, external storage devices, network or cloud storage devices, integrated circuits, etc. Additionally, in at least one embodiment, each of the at least one user device 28 is in the possession of a user who is desirous of utilizing the system 20 obtain the at least one reward 22 in exchange for booking stays at more than one lodging facility 24.

Furthermore, the various components of the at least one user device 28 may reside on a single computing and/or electronic device, or may separately reside on two or more computing and/or electronic devices in communication with one another. In at least one embodiment, the functionality provided by the user application 32 resides remotely in memory on the computing system 26 and/or database 30, with the at least one user device 28 capable of accessing said functionality via an online portal hosted by the computing system 26 and/or database 30, either in addition to or in lieu of the user application 32 residing locally in memory 34 on the at least one user device 28. It should be noted that, for simplicity purposes, the functionality provided by the user application 32 will be described herein as such—even though certain embodiments may provide said functionality through an online portal. It should also be noted that, for simplicity purposes, when discussing functionality and the various methods that may be carried out by the system 20 herein, the terms “user device” 28 and “user application” 32 are intended to be interchangeable.

With continued reference to FIG. 1, in at least one embodiment, the at least one user device 28 provides an at least one display screen 36 for providing an at least one graphical user interface to assist the associated user in possession of said user device 28 to access and utilize the various functions provided by the system 20. In at least one such embodiment, the at least one display screen 36 is a touchscreen.

In at least one embodiment, as illustrated in the architecture diagram of FIG. 2, the computing system 26—or the at least one database 30—stores and manages a user account 38 for each user containing various details related to the user and each of the at least one reward 22 associated with the user—i.e., each reward 22 that has been earned by the user through the system 20. In at least one embodiment, each user account 38 contains at least one of a unique account identifier 40 (such as an alphanumeric username or email address, for example), an email address 42 belonging to the associated user, a mailing address 44 belonging to the associated user, a financial account 46 belonging to the associated user (such as a bank account or PayPal® account, for example), a reward table 48 containing details related to each of the at least one reward 22 that has been earned by the associated user through the system 20, a reward balance 50 containing an aggregated current total value of the at least one reward 22 contained in the reward table 48, and a booking history 52 containing details related to each of the stays that the associated user has booked at participating or otherwise included lodging facilities 24.

In at least one embodiment, as illustrated in the architecture diagram of FIG. 3, each of the at least one reward 22 contains, or is otherwise associated with, at least one of a unique reward identifier 54 (such as an alphanumeric name, for example), a reward owner 56 containing the account identifier 40 of the user who earned the associated reward 22, a reward amount 58 containing a quantifiable value (either based on a desired currency or a pre-defined point system as administered by the system 20) that may be selectively redeemed by the reward owner 56, a reward date 60 containing the date on which the associated reward 22 was earned by the reward owner 56, an expiration date 62 containing the date on which any potential bonus multipliers for the reward amount 58 (as discussed further below) will expire and be no longer redeemable by the reward owner 56 (though, in at least one embodiment, the expiration date 62 contains the date on which the reward amount 58 itself will expire), an originating lodging 64 containing a name of the lodging facility 24 where the reward owner 56 earned the associated reward 22 based on the reward owner 56 previously booking a stay there, and an originating location 66 containing the geographic location of the originating lodging 64 (such as the specific geographic location of the originating lodging or, alternatively, a more general location such as the city and/or state in which the originating lodging is located).

It should be noted that while the term “table” is used herein to describe certain exemplary data structures, in at least one embodiment, any other suitable data type or data structure, or combinations thereof, now known or later developed, capable of storing the appropriate data, may be substituted. Thus, the present invention should not be read as being so limited.

As discussed in detail below, the system 20 may be utilized in a variety of contexts. In each such context, the system 20 is configured for incentivizing the at least one user to book stays at a variety of lodging facilities 24. As such, the system 20 and associated methods described herein should not be read as being so limited, but instead can be utilized in any context, now known or later conceived, where providing such incentives is desired.

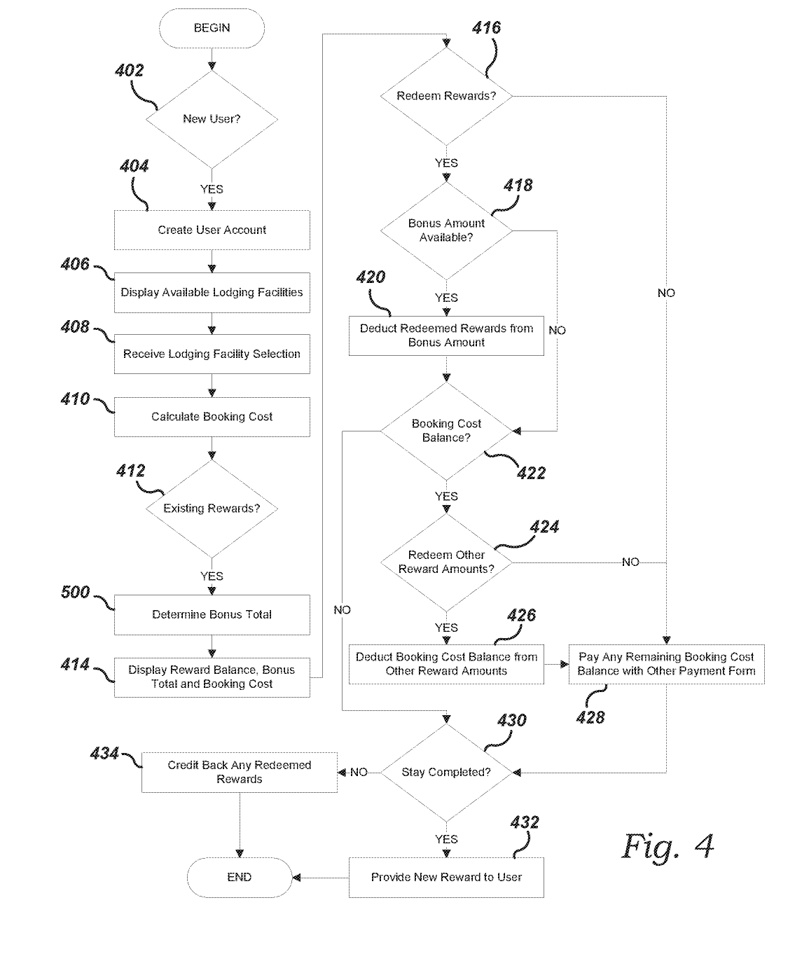

In at least one embodiment, as illustrated in the flow diagram of FIG. 4, through the user application 32 residing either locally in memory 34 on the at least one user device 28 or remotely on the computing system 26 and/or database 30, upon the associated user desiring to utilize the system 20 to earn and redeem rewards 22 through booking stays at participating lodging facilities 24, the computing system 26 first determines whether the associated user is new to the system 20 (402). If the associated user is new, the user is required to properly register a new user account 38 with the computing system 26 via the user device 28 (404)—or, alternatively, via any other computing or electronic device capable of communicating with the computing system 26. Once the user has been registered with the computing system 26, the user is provided with the ability to selectively browse available lodging facilities 24 (406) based on one or more specified criteria, including but not limited to a desired location, a desired arrival date, a desired departure date, a desired price range, and a desired user-based or facility-based rating. Upon the user selecting a desired lodging facility 24 for potential booking (408), the computing system 26 calculates a total booking cost for the user's desired stay (410), based on a nightly rate of the lodging facility 24 and a duration (i.e., number of nights) of the user's desired stay. If so directed by the user or suggested by the computing system 26, the computing system 26 then determines whether the user has any existing rewards 22 that could potentially be redeemed toward the current booking (412). In at least one embodiment, the computing system 26 makes this determination based on whether the reward table 48 associated with the user contains any rewards 22. Upon determining that the user has at least one existing reward 22, the computing system 26 checks each reward 22 to determine whether said reward 22 is eligible to receive a pre-defined bonus multiplier (500). As explained further below, in at least one embodiment, each of the at least one reward 22 is eligible to receive the bonus multiplier if (1) the associated expiration date 62 of the reward 22 has not yet been reached, and (2) a distance between the associated originating location 66 of the reward 22 and the desired lodging facility 24 is greater than a pre-defined minimum distance. In other words, in at least one such embodiment, the at least one user is provided with a relatively greater reward amount 58 (by virtue of the bonus multiplier) by booking a stay at a lodging facility 24 in a different geographic location relative to at least one of the other lodging facilities 24 where the user has previously stayed. In at least one alternate embodiment, each of the at least one reward 22 is eligible to receive the bonus multiplier if the distance between the associated originating location 66 of the reward 22 and the desired lodging facility 24 is greater than a pre-defined minimum distance—i.e., expiration dates are not utilized. Thus, the system 20 incentivizes the at least one user to book stays at a variety of lodging facilities 24, rather than the same lodging facility 24—or multiple lodging facilities 24 in the same general location—time and time again.

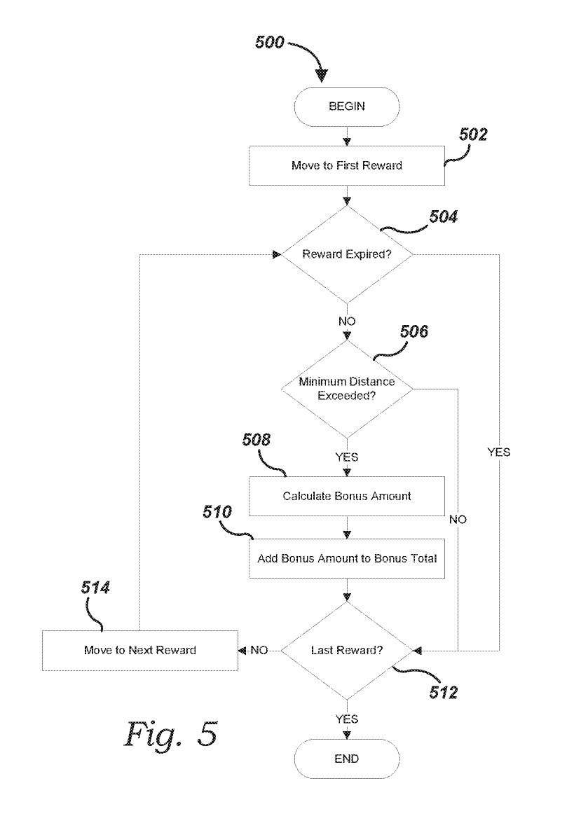

In at least one embodiment, as illustrated in the flow diagram of FIG. 5, upon determining that the user has at least one existing reward 22, the computing system 26 checks a first one of the at least one existing reward 22 in the reward table 48 (502). If the associated expiration date 62 of the reward 22 has not yet been reached (504) and the distance between the associated originating location 66 of the reward 22 and the desired lodging facility 24 is greater than the pre-defined minimum distance (506), the computing system 26 calculates an appropriate bonus amount for the reward 22 based on the pre-defined bonus multiplier as applied to the associated reward amount 58 (508). In at least one embodiment, the minimum distance is a constant value, such as thirty miles for example. Thus, in such an embodiment, if the distance between the associated originating location 66 of the reward 22 and the desired lodging facility 24 is greater than thirty miles (i.e., if the desired lodging facility 24 is located more than thirty miles away from the originating lodging 64 where the reward 22 was previously earned by the user), the computing system 26 will calculate the appropriate bonus amount. Additionally, in at least one embodiment, the bonus multiplier is a constant value, such as two for example. Thus, in such an embodiment, if the associated expiration date 62 of the reward 22 has not yet been reached (504) and the distance between the associated originating location 66 of the reward 22 and the desired lodging facility 24 is greater than the pre-defined minimum distance (506), the computing system 26 calculates the bonus amount by multiplying the associated reward amount 58 by two (i.e., the bonus amount would be double the reward amount 58). In further embodiments, the computing system 26 utilizes a sliding scale for determining an appropriate bonus multiplier when calculating the bonus amount, wherein the greater the distance between the associated originating location 66 of the reward 22 and the desired lodging facility 24, the greater the bonus multiplier becomes. In still further embodiments, the bonus amount for a given reward 22 may be calculated using any other mathematical formulas and/or variables now known or later conceived. Once the bonus amount has been calculated (508), the bonus amount is added to a bonus total representing the aggregated bonus amount values, across each of the at least one existing reward 22 in the reward table 48, that are eligible to be redeemed toward a stay at the desired lodging facility 24 (510). Alternatively, if the associated expiration date 62 of the reward 22 has already been reached or the distance between the associated originating location 66 of the reward 22 and the desired lodging facility 24 is less than the pre-defined minimum distance, the reward 22 is not eligible for receiving a bonus multiplier, and so no bonus amount is calculated for that reward 22. The computing system 26 moves to the next reward 22 (if any) in the reward table 48 (514) and repeats these same steps until each of the rewards 22 have been checked relative to the desired lodging facility 24 (512).

Referring again to FIG. 4, in at least one embodiment, the computing system 26 displays the reward balance 50 (i.e., the aggregated value of the reward amounts 58 associated with each of the at least one reward 22 contained in the reward table 48) and any bonus total (i.e., the aggregated bonus amount values, across each of the at least one reward 22 in the reward table 48, that are eligible to be redeemed toward a stay at the desired lodging facility 24), along with the booking cost, via the display screen 36 of the at least one user device 28 (414). In at least one embodiment, the user is given the option of redeeming the at least one reward 22 toward booking a stay at the desired lodging facility 24 (416), through which the booking cost would be reduced proportionally by the specified portion of the reward balance 50 and/or bonus total to be redeemed. In at least one alternate embodiment, rather than the booking cost being reduced, the user is instead subsequently reimbursed for the specified portion of the reward balance 50 and/or bonus total to be redeemed. In another such alternate embodiment, rather than the booking cost being reduced or the user subsequently reimbursed for the specified portion of the reward balance 50 and/or bonus total to be redeemed, the user is instead provided a voucher or other form of full or partial payment to be used for payment towards the stay in advance of, during, or at the end of a stay.

In at least one embodiment, upon the user electing to redeem at least a portion of the reward balance 50 and/or bonus total toward booking a stay at the desired lodging facility 24, the computing system 26 deducts from the at least one reward 22 the specified portion of the reward balance 50 and/or bonus total to be redeemed. In at least one such embodiment, where the bonus total is greater than zero—i.e., if any of the at least one reward 22 is eligible to receive a bonus multiplier—(418), the computing system 20 deducts from the bonus total first, with the corresponding reward amount 58 of the associated at least one reward 22 also being reduced (420). For example, if a given user has three rewards 22 in their reward table 48, having reward amounts 58 of $50, $150 and $200, respectively, and the $50 and $150 reward amounts 58 are eligible for a bonus multiplier of two—thereby creating a $100 bonus amount for the $50 reward amount 58 ($50×2), and a $300 bonus amount for the $150 reward amount 58 ($150×2), or an aggregated $400 bonus total ($100 +$300)—and the booking cost is $200, the computing system 26 would deduct $200 from the bonus total, and would also reduce the respective reward amounts 58 by a proportional amount, though adjusted back down by the bonus multiplier—i.e., the $50 and $150 reward amounts 58, in aggregate, would be reduced by $100 ($200/2). In at least one embodiment, the redeemed portion of the bonus total is deducted equally across each of the at least one eligible reward 22. However, in further embodiments, any other method for deducting the redeemed portion of the bonus total may be substituted, such as deducting from the eligible reward 22 having the earliest associated reward date 60 (or the soonest associated expiration date 62) first, for example. In at least one embodiment, the user is provided with the option of redeeming a portion of the bonus total toward booking a stay at the desired lodging facility 24 only if the bonus total is greater than or equal to the average nightly rate or one of the nightly rates of the desired lodging facility 24.

In at least one embodiment, should a remaining balance exist with respect to the booking cost (422) after redeeming the desired amount of the bonus total (if any), the user is provided with the option of covering the remaining balance by redeeming a portion of any remaining reward balance 50 (424, 426) and/or by providing a different form of payment (such as cash, check or credit card, for example) (428). In at least one embodiment, the redeemed portion of the reward balance 50 is deducted equally across each of the at least one reward 22. However, in further embodiments, any other method for deducting the redeemed portion of the reward balance 50 may be substituted, such as deducting from the reward 22 having the earliest associated reward date 60 (or the soonest associated expiration date 62) first, for example. In at least one embodiment, upon the entire reward amount 58 of a given reward 22 being redeemed, the reward 22 is removed from the reward table 48 of the associated user.

With continued reference to FIG. 4, in at least one embodiment, upon the user completing their stay at the desired lodging facility 24 (430), the computing system 26 calculates and adds a new reward 22 to the associated user account 38 in connection with their stay at the lodging facility 24 (432). In at least one embodiment, the associated reward amount 58 is calculated based on a pre-defined percentage of the booking cost—for example, five percent (5%) of the booking cost. In at least one alternate embodiment, the reward amount 58 is simply a pre-defined constant amount—such as $10 for example. In at least one further embodiment, the reward amount 58 is calculated based on any costs associated with the user's stay at the lodging facility 24—including but not limited to the booking cost, any associated taxes or fees, and any ancillary items such as lodging food, lodging drinks, lodging parking, lodging spa, or any other lodging amenities, services, or related services that the user may purchase. In still further embodiments, the estimated reward amount 58 may be calculated using any other mathematical formulas and/or variables now known or later conceived. In at least one embodiment, the reward amount 58 is calculated based on any portion of the booking cost that was paid using a form of payment other than the reward balance 50 or bonus total. In at least one embodiment, in the event the user does not complete their stay at the desired lodging facility 24 (for example, if the user timely cancels their reservation), the computing system 26 credits the user account 38 with the associated reward amounts 58 and/or bonus amounts that were previously redeemed and deducted from the at least one reward 22 in connection with the booking (434).

Aspects of the present specification may also be described as follows:

1. A method for administering a lodging reward system for incentivizing an at least one user by providing said user with an at least one reward, having a redeemable value, in exchange for booking stays at more than one lodging facility, the method comprising the steps of: implementing a central computing system configured for receiving and processing data related to the at least one user and associated at least one reward;

establishing a user account associated with a one of the at least one user via a user device under the control of the at least one user and in selective communication with the computing system, the user account containing at least one of a unique account identifier, a reward table containing details related to each of the at least one reward that has been earned by the associated user, and a reward balance containing an aggregated total redeemable value of the at least one reward contained in the reward table; and upon a one of the at least one user desiring to book a stay at a desired lodging facility: calculating a booking cost for the user's desired stay; upon determining that the reward table of the associated user account contains at least one reward, for each such reward contained therein: upon determining that a distance between an originating location, associated with said reward, and the desired lodging facility is greater than a pre-defined minimum distance: calculating a bonus amount for said reward; and adding the bonus amount to a bonus total representing an aggregated redeemable value of the at least one bonus amount; and upon the user electing to redeem a specified amount of the bonus total toward the booking cost: deducting the specified amount from the bonus total; and deducting a proportional amount from the reward amount of the at least one associated reward.

2. The method according to embodiment 1, further comprising the step of implementing an at least one database in communication with the computing system and configured for selectively storing said data related to the at least one user and associated at least one reward.

3. The method according to embodiments 1-2, further comprising the step of implementing a user application residing in memory on at least one of the computing system and the at least one user device.

4. The method according to embodiments 1-3, further comprising the step of allowing the at least one user to selectively browse available lodging facilities for potential booking.

5. The method according to embodiments 1-4, wherein the step of calculating a bonus amount for a given reward further comprises the step of multiplying the reward amount associated with said reward by a pre-defined bonus multiplier.

6. The method according to embodiments 1-5, further comprising the step of defining the bonus multiplier based on the distance between the originating location associated with said reward and the desired lodging facility, wherein the greater the distance between the originating location and the desired lodging facility, the greater the bonus multiplier.

7. The method according to embodiments 1-6, further comprising the step of notifying the user of at least one of the reward balance, bonus total, and booking cost.

8. The method according to embodiments 1-7, wherein the step of deducting the specified amount from the bonus total further comprises the step of deducting the specified amount equally across the bonus amount of each of the at least one associated reward.

9. The method according to embodiments 1-8, further comprising the step of allowing the user to selectively redeem a specified amount of the bonus total only if the bonus total is greater than or equal to an average nightly rate or one of the nightly rates of the desired lodging facility.

10. The method according to embodiments 1-9, wherein the step of allowing the user to selectively cover the remaining balance by redeeming a specified amount of the reward balance toward the booking cost, further comprises the step of deducting the specified amount from the reward balance.

11. The method according to embodiments 1-10, wherein the step of deducting the specified amount from the reward balance further comprises the step of deducting the specified amount equally across the reward amount of each of the at least one associated reward in the reward table.

12. The method according to embodiments 1-11, further comprising the step of, upon determining that the entire reward amount of a given reward has been redeemed, removing the reward from the reward table of the associated user.

13. The method according to embodiments 1-12, further comprising the step of, upon determining that a remaining balance exists with respect to the booking cost, allowing the user to selectively cover the remaining balance by redeeming a specified amount of the reward balance toward the booking cost or providing a different form of payment.

14. The method according to embodiments 1-13, further comprising the step of, upon determining that the user has completed the booked stay at the desired lodging facility, calculating a reward amount for a new reward to be added to the reward table of the associated user account, based on the stay at the desired lodging facility.

15. The method according to embodiments 1-14, further comprising the step of populating at least one of a unique reward identifier, a reward owner, a reward amount, a reward date, an expiration date, an originating lodging, and an originating location associated with the new reward.

16. The method according to embodiments 1-15, further comprising the step of, upon determining that the user did not complete the booked stay at the desired lodging facility, crediting the user account with any reward balance or bonus total that was previously redeemed and deducted in connection with the booked stay.

17. A method for administering a lodging reward system for incentivizing an at least one user by providing said user with an at least one reward, having a redeemable value, in exchange for booking stays at more than one lodging facility, the method comprising the steps of: implementing a central computing system configured for receiving and processing data related to the at least one user and associated at least one reward; establishing a user account associated with a one of the at least one user via a user device under the control of the at least one user and in selective communication with the computing system, the user account containing at least one of a unique account identifier, a reward table containing details related to each of the at least one reward that has been earned by the associated user, and a reward balance containing an aggregated total redeemable value of the at least one reward contained in the reward table; and upon a one of the at least one user desiring to book a stay at a desired lodging facility: calculating a booking cost for the user's desired stay; upon determining that the reward table of the associated user account contains at least one reward, for each such reward contained therein: upon determining that an expiration date, associated with said reward, has not yet been reached: upon determining that a distance between an originating location, associated with said reward, and the desired lodging facility is greater than a pre-defined minimum distance: calculating a bonus amount for said reward by multiplying the reward amount associated with said reward by a pre-defined bonus multiplier; and adding the bonus amount to a bonus total representing an aggregated redeemable value of the at least one bonus amount; and upon the user electing to redeem a specified amount of the bonus total toward the booking cost: deducting the specified amount from the bonus total; and deducting a proportional amount from the reward amount of the at least one associated reward, based on the pre-defined bonus multiplier.

18. A lodging reward system for incentivizing an at least one user by providing said user with an at least one reward, having a redeemable value, in exchange for booking stays at more than one lodging facility, the system comprising: a central computing system configured for receiving and processing data related to the at least one user and associated at least one reward; an at least one user device under the control of the at least one user and in selective communication with the computing system; and a user account associated with a one of the at least one user, the user account containing at least one of a unique account identifier, a reward table containing details related to each of the at least one reward that has been earned by the associated user, and a reward balance containing an aggregated total redeemable value of the at least one reward contained in the reward table; wherein, upon a one of the at least one user desiring to book a stay at a desired lodging facility, the system is configured for: calculating a booking cost for the user's desired stay;

upon determining that the reward table of the associated user account contains at least one reward, for each such reward contained therein: upon determining that a distance between an originating location, associated with said reward, and the desired lodging facility is greater than a pre-defined minimum distance: calculating a bonus amount for said reward; and adding the bonus amount to a bonus total representing an aggregated redeemable value of the at least one bonus amount; and upon the user electing to redeem a specified amount of the bonus total toward the booking cost: deducting the specified amount from the bonus total; and deducting a proportional amount from the reward amount of the at least one associated reward.

19. The lodging reward system according to embodiment 18, further comprising an at least one database in communication with the computing system and configured for selectively storing said data related to the at least one user and associated at least one reward.

20. The lodging reward system according to embodiments 18-19, wherein the at least one reward contains at least one of a unique reward identifier, a reward owner, a reward amount, a reward date, an expiration date, an originating lodging, and an originating location associated with the new reward.

21. The lodging reward system according to embodiments 18-20, wherein the system is further configured for implementing a user application residing in memory on at least one of the computing system and the at least one user device.

22. The lodging reward system according to embodiments 18-21, wherein the system is further configured for allowing the at least one user to selectively browse available lodging facilities for potential booking.

23. The lodging reward system according to embodiments 18-22, wherein while calculating a bonus amount for a given reward, the system is further configured for multiplying the reward amount associated with said reward by a pre-defined bonus multiplier.

24. The lodging reward system according to embodiments 18-23, wherein the system is further configured for defining the bonus multiplier based on the distance between the originating location associated with said reward and the desired lodging facility, wherein the greater the distance between the originating location and the desired lodging facility, the greater the bonus multiplier.

25. The lodging reward system according to embodiments 18-24, wherein the system is further configured for notifying the user of at least one of the reward balance, bonus total, and booking cost.

26. The lodging reward system according to embodiments 18-25, wherein while deducting the specified amount from the bonus total, the system is further configured for deducting the specified amount equally across the bonus amount of each of the at least one associated reward.

27. The lodging reward system according to embodiments 18-26, wherein the system is further configured for allowing the user to selectively redeem a specified amount of the bonus total only if the bonus total is greater than or equal to an average nightly rate or one of the nightly rates of the desired lodging facility.

28. The lodging reward system according to embodiments 18-27, wherein while allowing the user to selectively cover the remaining balance by redeeming a specified amount of the reward balance toward the booking cost, the system is further configured for deducting the specified amount from the reward balance.

29. The lodging reward system according to embodiments 18-28, wherein while deducting the specified amount from the reward balance, the system is further configured for deducting the specified amount equally across the reward amount of each of the at least one associated reward in the reward table.

30. The lodging reward system according to embodiments 18-29, wherein the system is further configured for, upon determining that the entire reward amount of a given reward has been redeemed, removing the reward from the reward table of the associated user.

31. The lodging reward system according to embodiments 18-30, wherein the system is further configured for, upon determining that a remaining balance exists with respect to the booking cost, allowing the user to selectively cover the remaining balance by redeeming a specified amount of the reward balance toward the booking cost or providing a different form of payment.

32. The lodging reward system according to embodiments 18-31, wherein the system is further configured for, upon determining that the user has completed the booked stay at the desired lodging facility, calculating a reward amount for a new reward to be added to the reward table of the associated user account, based on the stay at the desired lodging facility.

33. The lodging reward system according to embodiments 18-32, wherein the system is further configured for, upon determining that the user did not complete the booked stay at the desired lodging facility, crediting the user account with any reward balance or bonus total that was previously redeemed and deducted in connection with the booked stay.

In closing, regarding the exemplary embodiments of the present invention as shown and described herein, it will be appreciated that a lodging reward system and associated methods of use are disclosed and configured for incentivizing lodging guests to book stays at a variety of lodging facilities. Because the principles of the invention may be practiced in a number of configurations beyond those shown and described, it is to be understood that the invention is not in any way limited by the exemplary embodiments, but is generally directed to a lodging reward system and is able to take numerous forms to do so without departing from the spirit and scope of the invention.

Certain embodiments of the present invention are described herein, including the best mode known to the inventor(s) for carrying out the invention. Of course, variations on these described embodiments will become apparent to those of ordinary skill in the art upon reading the foregoing description. The inventor(s) expect skilled artisans to employ such variations as appropriate, and the inventor(s) intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising” (along with equivalent open-ended transitional phrases thereof such as “including,” “containing” and “having”) encompasses all the expressly recited elements, limitations, steps and/or features alone or in combination with un-recited subject matter; the named elements, limitations and/or features are essential, but other unnamed elements, limitations and/or features may be added and still form a construct within the scope of the claim. Specific embodiments disclosed herein may be further limited in the claims using the closed-ended transitional phrases “consisting of” or “consisting essentially of” in lieu of or as an amendment for “comprising.” When used in the claims, whether as filed or added per amendment, the closed-ended transitional phrase “consisting of” excludes any element, limitation, step, or feature not expressly recited in the claims. The closed-ended transitional phrase “consisting essentially of” limits the scope of a claim to the expressly recited elements, limitations, steps and/or features and any other elements, limitations, steps and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps and/or features specifically recited in the claim, whereas the meaning of the closed-ended transitional phrase “consisting essentially of” is being defined as only including those elements, limitations, steps and/or features specifically recited in the claim and those elements, limitations, steps and/or features that do not materially affect the basic and novel characteristic(s) of the claimed subject matter. Therefore, the open-ended transitional phrase “comprising” (along with equivalent open-ended transitional phrases thereof) includes within its meaning, as a limiting case, claimed subject matter specified by the closed-ended transitional phrases “consisting of” or “consisting essentially of.” As such, embodiments described herein or so claimed with the phrase “comprising” are expressly or inherently unambiguously described, enabled and supported herein for the phrases “consisting essentially of” and “consisting of.”

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

It should be understood that the logic code, programs, modules, processes, methods, and the order in which the respective elements of each method are performed are purely exemplary. Depending on the implementation, they may be performed in any order or in parallel, unless indicated otherwise in the present disclosure. Further, the logic code is not related, or limited to any particular programming language, and may comprise one or more modules that execute on one or more processors in a distributed, non-distributed, or multiprocessing environment.

The methods as described above may be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multi-chip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A method for administering a lodging reward system for incentivizing an at least one user by providing said user with an at least one reward, having a redeemable value, in exchange for booking stays at more than one lodging facility, the method comprising the steps of:
implementing a central computing system configured for receiving and processing data related to the at least one user and associated at least one reward;
establishing a user account associated with a one of the at least one user via a user device under the control of the at least one user and in selective communication with the computing system, the user account containing at least one of a unique account identifier, a reward table containing details related to each of the at least one reward that has been earned by the associated user, and a reward balance containing an aggregated total redeemable value of the at least one reward contained in the reward table; and
upon a one of the at least one user desiring to book a stay at a desired lodging facility:
calculating a booking cost for the user's desired stay;
upon determining that the reward table of the associated user account contains at least one reward, for each such reward contained therein:
upon determining that a distance between an originating location, associated with said reward, and the desired lodging facility is greater than a pre-defined minimum distance:
calculating a bonus amount for said reward; and
adding the bonus amount to a bonus total representing an aggregated redeemable value of the at least one bonus amount; and
upon the user electing to redeem a specified amount of the bonus total toward the booking cost:
deducting the specified amount from the bonus total; and
deducting a proportional amount from the reward amount of the at least one associated reward.

2. The method of claim 1, further comprising the step of implementing an at least one database in communication with the computing system and configured for selectively storing said data related to the at least one user and associated at least one reward.

3. The method of claim 1, further comprising the step of implementing a user application residing in memory on at least one of the computing system and the at least one user device.

4. The method of claim 1, further comprising the step of allowing the at least one user to selectively browse available lodging facilities for potential booking.

5. The method of claim 1, wherein the step of calculating a bonus amount for a given reward further comprises the step of multiplying the reward amount associated with said reward by a pre-defined bonus multiplier.

6. The method of claim 5, further comprising the step of defining the bonus multiplier based on the distance between the originating location associated with said reward and the desired lodging facility, wherein the greater the distance between the originating location and the desired lodging facility, the greater the bonus multiplier.

7. The method of claim 1, further comprising the step of notifying the user of at least one of the reward balance, bonus total, and booking cost.

8. The method of claim 1, wherein the step of deducting the specified amount from the bonus total further comprises the step of deducting the specified amount equally across the bonus amount of each of the at least one associated reward.

9. The method of claim 1, further comprising the step of allowing the user to selectively redeem a specified amount of the bonus total only if the bonus total is greater than or equal to one of an average nightly rate or one of the nightly rates of the desired lodging facility.

10. The method of claim 1, wherein the step of allowing the user to selectively cover the remaining balance by redeeming a specified amount of the reward balance toward the booking cost, further comprises the step of deducting the specified amount from the reward balance.

11. The method of claim 10, wherein the step of deducting the specified amount from the reward balance further comprises the step of deducting the specified amount equally across the reward amount of each of the at least one associated reward in the reward table.

12. The method of claim 11, further comprising the step of, upon determining that the entire reward amount of a given reward has been redeemed, removing the reward from the reward table of the associated user.

13. The method of claim 1, further comprising the step of, upon determining that a remaining balance exists with respect to the booking cost, allowing the user to selectively cover the remaining balance by redeeming a specified amount of the reward balance toward the booking cost or providing a different form of payment.

14. The method of claim 1, further comprising the step of, upon determining that the user has completed the booked stay at the desired lodging facility, calculating a reward amount for a new reward to be added to the reward table of the associated user account, based on the stay at the desired lodging facility.

15. The method of claim 1, further comprising the step of populating at least one of a unique reward identifier, a reward owner, a reward amount, a reward date, an expiration date, an originating lodging, and an originating location associated with the new reward.

16. The method of claim 1, further comprising the step of, upon determining that the user did not complete the booked stay at the desired lodging facility, crediting the user account with any reward balance or bonus total that was previously redeemed and deducted in connection with the booked stay.

17. A method for administering a lodging reward system for incentivizing an at least one user by providing said user with an at least one reward, having a redeemable value, in exchange for booking stays at more than one lodging facility, the method comprising the steps of:
implementing a central computing system configured for receiving and processing data related to the at least one user and associated at least one reward;
establishing a user account associated with a one of the at least one user via a user device under the control of the at least one user and in selective communication with the computing system, the user account containing at least one of a unique account identifier, a reward table containing details related to each of the at least one reward that has been earned by the associated user, and a reward balance containing an aggregated total redeemable value of the at least one reward contained in the reward table; and
upon a one of the at least one user desiring to book a stay at a desired lodging facility:
calculating a booking cost for the user's desired stay;
upon determining that the reward table of the associated user account contains at least one reward, for each such reward contained therein:
upon determining that an expiration date, associated with said reward, has not yet been reached:
upon determining that a distance between an originating location, associated with said reward, and the desired lodging facility is greater than a pre-defined minimum distance:
calculating a bonus amount for said reward by multiplying the reward amount associated with said reward by a pre-defined bonus multiplier; and
adding the bonus amount to a bonus total representing an aggregated redeemable value of the at least one bonus amount; and
upon the user electing to redeem a specified amount of the bonus total toward the booking cost:
deducting the specified amount from the bonus total; and
deducting a proportional amount from the reward amount of the at least one associated reward, based on the pre-defined bonus multiplier.

18. A lodging reward system for incentivizing an at least one user by providing said user with an at least one reward, having a redeemable value, in exchange for booking stays at more than one lodging facility, the system comprising:
a central computing system configured for receiving and processing data related to the at least one user and associated at least one reward;
an at least one user device under the control of the at least one user and in selective communication with the computing system; and
a user account associated with a one of the at least one user, the user account containing at least one of a unique account identifier, a reward table containing details related to each of the at least one reward that has been earned by the associated user, and a reward balance containing an aggregated total redeemable value of the at least one reward contained in the reward table;
wherein, upon a one of the at least one user desiring to book a stay at a desired lodging facility, the system is configured for:
calculating a booking cost for the user's desired stay;
upon determining that the reward table of the associated user account contains at least one reward, for each such reward contained therein:
upon determining that a distance between an originating location, associated with said reward, and the desired lodging facility is greater than a pre-defined minimum distance:
calculating a bonus amount for said reward; and
adding the bonus amount to a bonus total representing an aggregated redeemable value of the at least one bonus amount; and
upon the user electing to redeem a specified amount of the bonus total toward the booking cost:
deducting the specified amount from the bonus total; and
deducting a proportional amount from the reward amount of the at least one associated reward.

19. The lodging reward system of claim 18, further comprising an at least one database in communication with the computing system and configured for selectively storing said data related to the at least one user and associated at least one reward.

20. The lodging reward system of claim 18, wherein the at least one reward contains at least one of a unique reward identifier, a reward owner, a reward amount, a reward date, an expiration date, an originating lodging, and an originating location associated with the new reward.
